(19) United States
(12) Patent Application Publication
(10) Pub. No.: US 2012/0328229 A1
(43) Pub. Date: Dec. 27, 2012

(54) Optical Module

(75) Inventors: Kenji Kogo, Koganei (JP); Yasunobu Matsuoka, Hachioji (JP); Shigeki Makino, Tokyo (JP)

(73) Assignee: Hitachi, Ltd., Tokyo (JP)

(21) Appl. No.: 13/490,513

(22) Filed: Jun. 7, 2012

(30) Foreign Application Priority Data
Jun. 27, 2011 (JP) 2011-141389

(51) Int. Cl. G02F 1/295; G02B 6/36

(52) U.S. Cl. 385/8; 385/88

(57) ABSTRACT

There is provided an optical module including photonic devices set in array, prepared by integrating a plurality of photonic devices with each other in such a state as arranged in such a array as to enable light beams to output in the common direction. The plural photonic devices each include a first electrode, and a second electrode, arranged in the same direction as the plural photonic devices are arranged, and the first and second electrodes of the photonic devices adjacent to each other are disposed such that respective electrode layouts are a mirror image of each other.

### CLAIM OF PRIORITY

The present application claims priority from Japanese patent application JP 2011-141389 filed on Jun. 27, 2011, the content of which is hereby incorporated by reference into this application.

### FIELD OF THE INVENTION

The present invention relates to an optical module serving as a transmitter in optical transmission using optical fibers between communication apparatuses, between apparatuses such as data processing devices, and so forth, or within an apparatus at a time when a high-speed optical signal is transmitted.

### BACKGROUND OF THE INVENTION

In information and communication fields, rapid upgrading of information and communications traffic whereby high-speed exchange of bulk data by use of light is executed has lately been under way, and there has so far been developed an optical fiber network over a relatively long distance not less than several km such as the basic system, metropolitan system, and access system. In order to process bulk data without a delay across even an extremely short distance such as a distance between transmission apparatuses (several to several hundred m) or a distance (several to several hundred cm) within a transmission apparatus from now on, it is effective to turn a signal-interconnection optical.

As for implementation of an optical interconnection between transmission apparatuses, or within a transmission apparatus, in the case of a transmission apparatus such as, for example, a router/a switch, and so forth, a high frequency signal transmitted via an optical fiber from outside such as Ethernet is inputted to a circuit board called a line card. One backplane includes several sheets of the line cards, and input signals to the respective line cards are further collected to a circuit board called a switch card via the backplate to be processed by an LSI in the switch card before being outputted to the respective line cards via the backplate again. Herein, with the presently available apparatus, signals at not less than 600 Gbps from the respective line cards are presently collected by the switch card via the backplane. In order to transmit the signals via the present electrical interconnections, it is necessary to divide the signals so as to be at a transmission rate on the order of 1 to 6 Gbps per one interconnection by taking a transmission loss in consideration, so that there arise the needs for not less than 100 interconnections.

Furthermore, these high-frequency lines each require a waveform conditioning circuit, and countermeasures against reflection, or crosstalk between interconnections. The further a progress toward a larger capacity of a system is made from now on, thereby rendering it necessary for the apparatus to process information at not less than 1 Tbps, the more serious will be problems with the electrical interconnection according to the related art, such as the number of the interconnections, countermeasures against crosstalk, and so forth. In contrast, if a signal transmission line among the boards, that is, the line card within a transmission apparatus—the backplane—the switch card, and a signal transmission line between chips within the board are rendered optical, this will enable a high-frequency signal at not less than 25 Gbps to be propagated with a low loss, so that a small number of the interconnections will do, and even if a pitch between the lines is narrower, there does not occur a noise and crosstalk, caused by an interaction between the lines, because of high-frequency characteristics that light is not subjected to the effect of an electromagnetic field. Furthermore, since the optical interconnection has a feature in that reflection of light, and an optical loss do not have dependence on frequency, and control thereof can be implemented with ease, the needs for the countermeasures described as above can be eliminated, so that optical signal transmission within the apparatus holds great promise. Further, with a video equipment such as a video camera, and so forth, and a consumer equipment such as a PC, a mobile phone, and so forth, in addition to the router/the switch, higher-speed larger capacity in transmission of a video signal between a monitor and a terminal will be required to achieve higher definition of a video from now on, and problems with the electrical interconnection according to the related art, such as signal delay, the countermeasures against noise, and so forth, are expected to be pronounced, so that an optical signal transmission line will be effective.

Accordingly, attention has lately been focused on an optical interconnection technology as a technology for optical communications. In order to implement optical interconnection for application between transmission apparatuses or within a transmission apparatus, there arise the needs for an optical module and a circuit, manufactured by use of an inexpensive manufacturing means, the optical module being excellent in terms of function, miniaturization, integration, and component-mounting capability. A vertical cavity surface emitting laser (VCSEL), a photonic device in which a resonator is made up in the in-plane direction of a substrate, and a tapered mirror is disposed at a position where a main outgoing light beam of the resonator falls, or a photonic device in which only part of a resonator is made up in the in-plane direction, and a tapered mirror is disposed in the resonator over the surface of the substrate, and so forth have been proposed for use as a light source for such a high-speed optical interconnection module as has been described. The latter laser for emitting the main signal light beam in the direction of the surface of the substrate by use of the tapered mirror has various merits including high-output operation, and high-speed operation, at a high temperature, and reduction in coupling loss due to integration of lenses. With the latter laser, an operation at 85° C. and 25 Gbps has lately been reported as disclosed in “Uncooled 25-Gbps 2-km transmission of 1.3-μm Surface Emitting Laser”, by K. Adachi, et al., 22nd IEEE International Semiconductor Laser Conference, (ISLC2010), TuC5).

In the case where this tapered-mirror integration surface-emitting laser is actually applied to an optical module, how to supply a high-speed electrical signal without a loss will be an important problem. Further, an optical module in reality includes a number of constituent elements such as a laser driver integrated circuit (IC) for generating a high-speed electrical signal, an electrical interconnection for use in supplying the high-speed electrical signal to a photonic device, a substrate with the electrical interconnection formed thereon, a photodetector having a monitor function for receiving a portion of light outgoing from the photonic device, and feeding back an appropriate drive condition of the photonic device, and so forth. Miniaturization, and low power consumption have been highly required of an optical module in recent years, and therefore, how to compactly mount a plurality of the constituent elements in the module has since become an important issue.

Accordingly, there has since been developed a scheme whereby high-speed and high-density optical transmission lines are arranged in array. Accordingly, a method described in Japanese Unexamined Patent Application Publication No. 2007-294725 “Semiconductor Composite Device, LED Head, and Image Forming Device” has been disclosed as a method whereby the photonic devices are also arranged in array with high efficiency, however, with this method, coupling between electrodes of the device is made via an interconnection, so that a parasitic-inductance component is added thereto, thereby creating a cause of deterioration in high-frequency characteristics.

### SUMMARY OF THE INVENTION

In FIG. 14, there is shown an electrode construction of a conventional array optical device. Photonic devices are arranged such that respective optical axes thereof are aligned with each other, thereby making up an array optical device 10. A p-electrode 11 and an n-electrode 12 are disposed at the respective photonic devices to be arranged at an identical electrode layout such that respective light-outgoing directions are in agreement with each other. A higher density is required of the optical interconnection, and as for the array optical device, the photonic devices are placed in a line at intervals for every 250 μm, the interval being identical to a core interval between arrayed optical fibers for general use. Accordingly, respective widths of the photonic devices need be 250 μm. However, in order to provide vias in the case of using a mounting board made of ceramics and so forth, there is the needs for a spacing not less than 200 μm between the photonic devices, together with a spacing 50 μm on one side of the electrode around the via, assuming that the via is 100 μm in diameter.

FIG. 15 is a view showing a conventional array optical device, and peripheral packaging thereof. The array optical device 10 is electrically coupled to a driver integrated circuit (IC) 16 via respective high-frequency lines 18, and optical waveguide 17 that are photo-coupled with high efficiency are disposed in the respective light-outgoing directions of the photonic devices. If the photonic devices have been arranged in a line at intervals for every 250 μm, it has been difficult to dispose a via 13 in the vicinity of the respective photonic devices while holding the respective line impedance of the high-frequency lines. For this reason, a distance up to a ground (GND) becomes longer, so that there occurs addition of a parasitic-inductance component in the case of high frequency at 25 Gbps, and so forth, in particular, thereby causing a problem of deterioration in the high-frequency characteristics.

Furthermore, a path of the photonic device, for letting heat generated to escape becomes longer, thereby rendering it harder to cause heat dissipation, and resulting in a rise of an ambient temperature around the photonic device, so that there have arisen problems such as deterioration in output strength of the photonic device, and so forth.

If a board has greater flexibility in layout of the electrodes of the photonic device, interconnections, vias, and so forth, such as, for example, disposition of the vias in the vicinity of the array optical device, these problems can be overcome.

It is therefore an object of the invention to increase flexibility in layout design of a photonic device.

To address the problems described as above, the inventor, et al. have developed the present invention. According to one aspect of the present invention, there is provided an optical module comprising photonic devices in array, prepared by integrating a plurality of photonic devices with each other, the plural photonic devices being arranged in such an array as to enable light beams to outgo in the same orientation. The plural photonic devices each comprise a first electrode, and a second electrode, arranged in the same direction as the plural photonic devices are arranged, and a first photonic device, and a second photonic device, adjacent to each other, and making up the plural photonic devices, are disposed in such a way as to display a mirror image of each other.

If the first photonic device, and the second photonic device, adjacent to each other, are disposed so as to display the mirror image of each other as described above, this will mean that the electrode of the first photonic device, and the electrode of the second photonic device, the respective electrodes being identical in polarity (plus, minus, or grounded), are disposed so as to be adjacent to each other, so that it becomes possible to decrease a pitch between the electrodes identical in polarity, or to integrate the electrodes with each other. Furthermore, flexibility in layout of the electrodes, interconnections, and vias, provided on a side of the optical module, adjacent to a substrate with the photonic devices mounted thereon.

Let us think about the case where a light-emitting laser diode device in which electrodes are disposed in such a way as to be asymmetrical with respect to an optical axis is used as a photonic device, and respective electrodes of proximity channels, the electrodes being identical in potential, are in common use. Normally, not less than one pair of a p-electrode 11, and an n-electrode are provided against one unit of light-emitting device. Accordingly, if an electrode pattern of a (2n−1)-th device is set to represent specular-reflection layout of that of a 2n-th device (n: natural number), this will cause the respective p-electrodes of adjacent photonic device as well as the respective n-electrodes of adjacent photonic device to be disposed in close proximity to each other. Further, in the substrate with an array optical device mounted thereon, common use can be made of electrode patterns on the n-electrode side in the case of an anodic drive, while common use can be made of electrode patterns on the p-electrode side in the case of a cathodic drive. In the case of using these electrodes in common use, there occurs an increase in both area and width of the electrodes although a device size and an interval between the devices have not been changed. Accordingly, a via can be disposed directly under the respective electrodes on a side of the device, adjacent to a ceramic substrate, provided that those electrodes are identical in potential to each other. As a result, the array optical device excellent in the high-frequency characteristics and radiation characteristics can be mounted.

With the present invention, it is possible to enhance flexibility in layout design of an optical module.

### BRIEF DESCRIPTION OF THE DRAWINGS

FIG. 1 is a top view showing an electrode pattern of an array optical device according to a first embodiment of the invention;

FIG. 2A is a top view of an arrayed optical module according to the first embodiment;

FIG. 2B is a sectional view of the arrayed optical module according to the first embodiment, taken on line A-A′ in FIG. 2A;

FIG. 2C is a sectional view of the arrayed optical module according to the first embodiment, taken on line B-B′ in FIG. 2A;

FIG. 3 is a top view showing an electrode composition of an array optical device according to a second embodiment of the invention;

FIG. 4A is a view showing the structure of a surface-emitting type arrayed optical module according to a third embodiment of the invention;

FIG. 4B is a top view of the surface-emitting type arrayed optical module according to the third embodiment;

FIG. 4C is a sectional view of the arrayed optical module according to the third embodiment, taken online C-C′ in FIG. 4B;

FIG. 5A is a view showing the structure of a surface-emitting type arrayed optical module according to a fourth embodiment of the invention;

FIG. 5B is a top view of the surface-emitting type arrayed optical module according to the fourth embodiment;

FIG. 5C is a view showing the surface-emitting type arrayed optical module according to the fourth embodiment, in as-packaged state;

FIG. 5D is a sectional view of the surface-emitting type arrayed optical module according to the fourth embodiment;

FIG. 5E is a view showing the surface-emitting type arrayed optical module according to the fourth embodiment, in as-packaged state;

FIG. 6 is a view showing the electrode pattern of a surface-emitting type array optical device bar according to a fifth embodiment of the invention;

FIG. 7A is a view showing an electrode pattern of the surface-emitting type array optical device according to the fifth embodiment of the invention;

FIG. 7B is a view showing another electrode pattern of the surface-emitting type array optical device according to the fifth embodiment of the invention;

FIG. 8A is a view showing the surface-emitting type arrayed optical module according to the fifth embodiment, in as-packaged state;

FIG. 8B is another view showing the surface-emitting type arrayed optical module according to the fifth embodiment, in as-packaged state;

FIG. 9 is a view showing an electrode pattern of a surface-emitting type array optical device according to a sixth embodiment of the invention;

FIG. 10 is a view showing an electrode pattern of a surface-emitting type array optical device according to a seventh embodiment of the invention;

FIG. 11 is a view showing an electrode pattern of a surface-emitting type array optical device according to an eighth embodiment of the invention;

FIG. 12 is a view showing an electrode pattern of a surface-emitting type array optical device according to a ninth embodiment of the invention;

FIG. 13A is a view showing an electrode pattern of a modulator integrated surface emitting array optical device according to a tenth embodiment of the invention;

FIG. 13B is a sectional view showing an electrode pattern of an edge-emitting type modulator-integration array optical device according to the tenth embodiment of the invention;

FIG. 14 is a view showing an electrode pattern of a conventional array optical device; and

FIG. 15 is a top view of an optical module with the conventional array optical device, mounted thereon.

### DETAILED DESCRIPTION OF THE PREFERRED EMBODIMENTS

Embodiments of the invention are described in detail hereinafter with reference to the accompanying drawings.

### First Embodiment

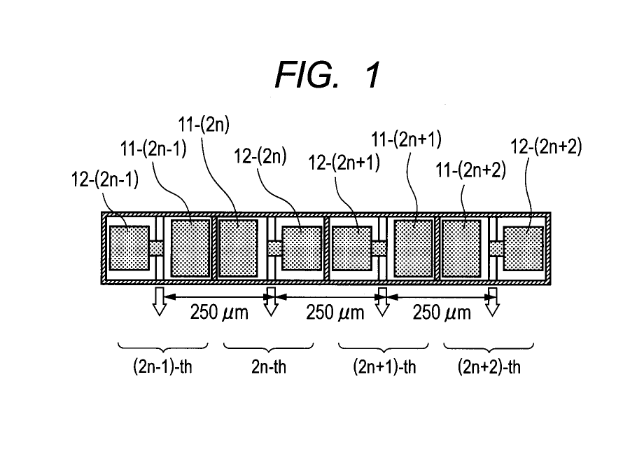

There is described hereinafter an optical module including an array optical device according to a first embodiment of the invention. FIG. 1 is a block diagram showing an electrode structure of a 4-channel array optical device. For a photonic device, use is made of a light-emitting device of a direct modulation system, and 4 units of the light-emitting devices are placed in a line such that the respective light-emitting devices are in parallel with each other. With the respective light-emitting devices, a p-electrode 11, and an n-electrode 12 are lined up in a direction formal to a light-outgoing direction such that a light beam outgoes in the same orientation. Further, the respective photonic device are arranged such that the respective light-outgoing directions are in agreement with each other, and integrated with each other. A pitch between the respective light-outgoing directions of the photonic devices is set to 250 μm. With this array optical device, the electrodes are arranged in the same direction as the photonic devices are arranged so as to be asymmetrical with respect to an optical axis. Then, an electrode pattern of a (2n−1)-th device is set to represent specular-reflection layout of an electrode pattern of a 2n-th device. In consequence, there is established an electrode construction such that the p-electrode 11 of the (2n−1)-th device is disposed so as to be directly adjacent to the p-electrode 11 of the 2n-th device, and the n-electrode 12 of the 2n-th device is disposed so as to be directly adjacent to the n-electrode 12 of the (2n+1)-th device. If the adjacent electrodes that are supplied with respective potentials identical in polarity are proximately disposed, this will provide a function serving as a countermeasure against noise.

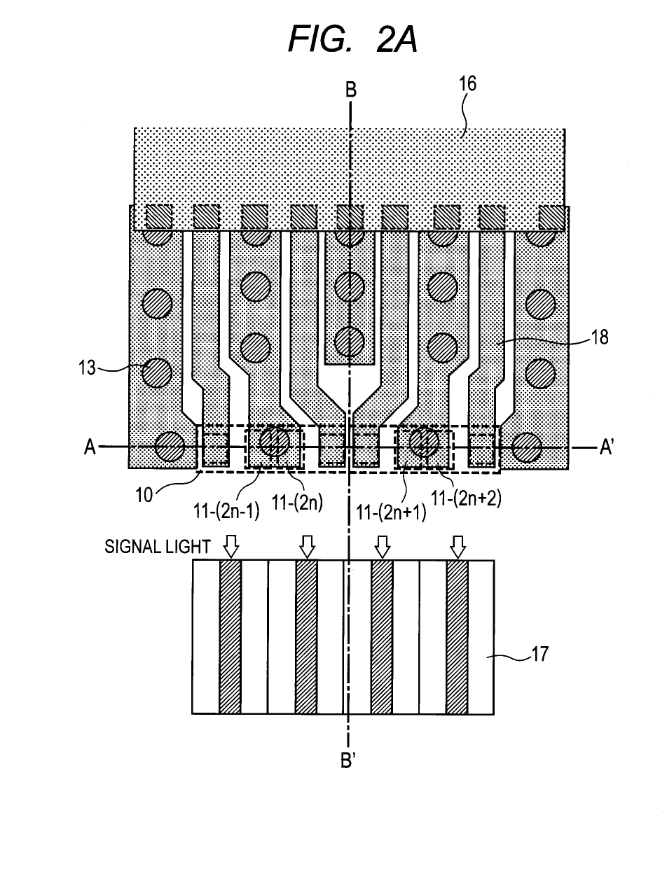

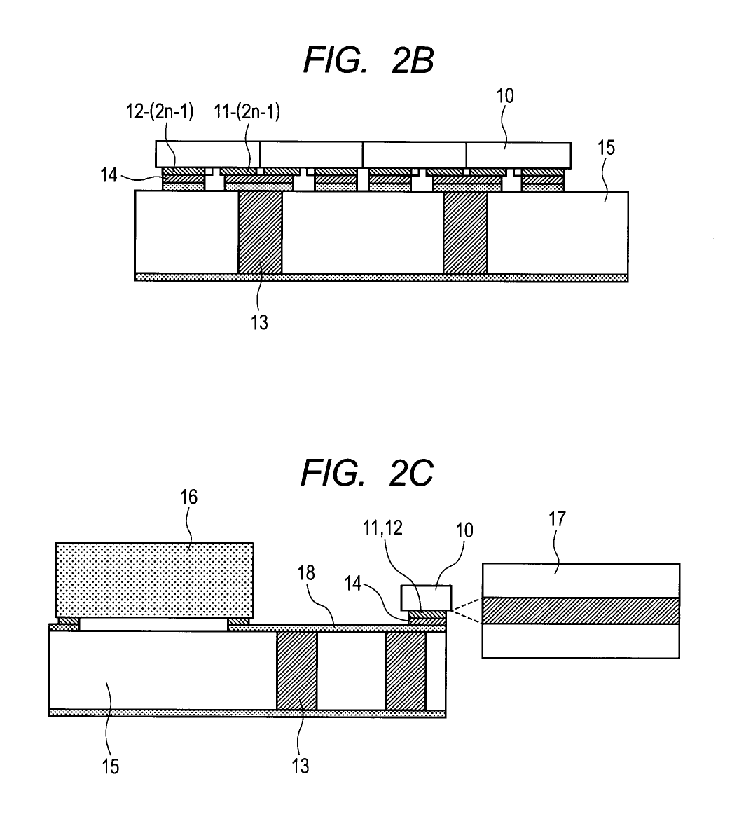

FIG. 2A is a top view of the optical module with the array optical device 10 mounted thereon. Arrayed optical waveguide 17, such as photo-coupled optical fibers, optical waveguides, and so forth are disposed in a direction in which the respective light beams of the array optical device 10 outgo (in the signal light direction) while a laser driver integrated circuit (IC) 16 is disposed on a side of the array optical device 10, opposite from the optical waveguide 17. The driver IC 16 is electrically coupled to the array optical device 10 via respective high-frequency lines 18. For the high-frequency lines 18, use is made of coplanar lines provided with a grounding (GND) pattern between the respective high-frequency lines of adjacent channels in order to reduce crosstalk between the adjacent channels. Further, if the transmission speeds of the respective channels of the array, in particular, are as high as 25 Gbps or higher, this will cause deterioration in the high-frequency characteristics because, in the case of packaging using a bonding wire, the wire acts as a parasitic inductance, and discontinuity will occur to the high-frequency line, thereby causing deterioration in the high-frequency characteristics. In addition, the wire ends up acing as an antenna to be coupled to the wire of an adjacent channel, thereby causing problems such as an increase in magnitude of crosstalk, and so forth. The array optical device 10 and the driver IC 16 are, therefore, mounted on a substrate 15 by use of flip chip mounting.

In this case, a signal is inputted to the n-electrodes to execute light modulation in order to cause the array optical device 10 to undergo cathodic driving. Accordingly, individual signals are inputted to the respective n-electrodes, however, the p-electrode 11 of the (2n−1)-th device, and the p-electrode 11 of the 2n-th device as well as the p-electrode 11 of the (2n+1)-th device, and the p-electrode 11 of the (2n+2)-th device are electrically coupled together for common use (integration) at the respective electrodes directly under the device, in the electrode pattern coupled thereto, on the substrate 15. The common use of the electrodes can contribute to reduction in the number of interconnections to be coupled to the array optical device 10, thereby enabling a higher density to be attained. Furthermore, the common use of the adjacent electrodes enables a width corresponding to two interconnections to be utilized, thereby enabling the vias to be disposed under the electrode pattern. In the case of using ceramics for a constituent material of the substrate 15, an electrode width not less than 200 μm is generally required in order that the via is provided, so that if the distance-interval between the light-outgoing directions is 250 μm in the case of a construction where unit photonic devices are arranged in parallel with each other, the most of the interval will be occupied by the GND pattern, rendering it difficult to form flexible high-frequency lines. With the present embodiment, however, since a mirror-image layout is adopted for both the adjacent channels, and the electrode pattern, the common use of the electrodes of the substrate 15 can be realized. Along with the common use of the electrodes of the substrate 15, the via 13 is provided under the electrode of the substrate 15, directly under the device. By coupling the via to a GND plane, a parasitic-inductance component up to the ground can be reduced, so that excellent high-frequency characteristics can be gained. Furthermore, since the via is disposed directly under the electrode of the substrate 15, a heat dissipation effect can be expected, thereby enabling an excellent operation even at a high temperature time.

FIG. 2B is a block diagram showing a sectional structure of the optical module, taken on line A-A′ in FIG. 2A. A AuSn solder 14 is provided at parts of the substrate 15, for connection with the respective electrodes of the photonic device, in advance, and the substrate 15 is placed over a heater, thereby executing positioning of the array optical device 10. Thereafter, an environment around the AuSn solder is changed to a nitrogen atmosphere to cause melting of the AuSn solder 14 by increasing a heater temperature to 300° C. or higher, thereby connecting the array optical device 10 with the substrate 15. That is, flip chip mounting is executed. At this point in time, a solder-slide control dam (not shown) is provided in the electrode pattern on the substrate 15 in order to prevent the AuSn solder 14 from spreading in wet state. With the solder dam provided, the AuSn solder 14 swells up in a dome-like shape, so that if variation on the order of several in height occurs to the p-electrode 11, and the n-electrode 12, respectively, an error can be absorbed by the AuSn solder 14. After the array optical device 10 is mounted, solder is provided at a position on the substrate 15, where the driver IC 16 is to be mounted, whereupon the driver IC 16 is mounted. At this point in time, use is made of solder that can melt around 200° C. at which the AuSn solder 14 used in fixing the array optical device 10 does not melt. That is, a temperature hierarchy is adopted. As is the case with the mounting by use of the AuSn solder, a solder-slide control dam is provided on the periphery of each of the electrodes of the substrate 15 in order to prevent the solder from spreading in wet state, thereby making adjustment toward a desired position simply by self-alignment.

FIG. 2C is a block diagram showing a sectional structure of the optical module, taken on line B-B′ in FIG. 2A. In order to couple the array optical device 10 to the respective optical waveguide 17 with high efficiency, the array optical device 10 is disposed at one end of the substrate 15 so as to be disposed in close proximity to the respective optical waveguide 17, thereby rendering it possible to execute highly efficient optical coupling.

### Second Embodiment

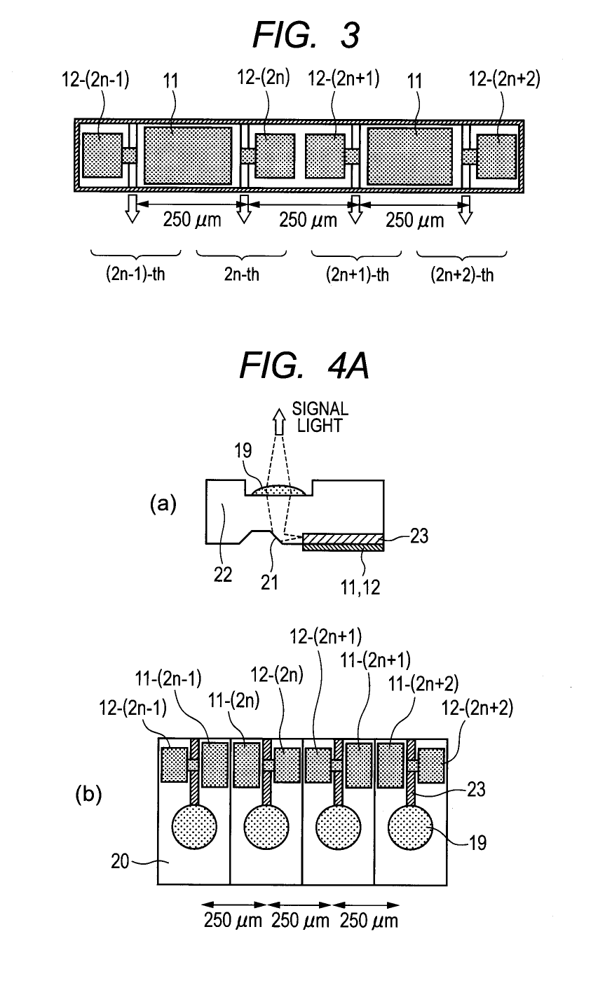

There is described hereinafter an optical module including an array optical device according to a second embodiment of the invention. FIG. 3 shows an electrode construction of the array optical device. The light-outgoing directions of the array optical device are in agreement with each other, and a distance-interval between the light-outgoing directions is set to 250 μm. Since the light-emitting device of the direct modulation system is normally one unit of diode, one pair of a p-electrode 11, and an n-electrode 12 are required of an active layer for emitting light. With the 4-channel array optical device, four pairs of the p-electrode 11, and the n-electrode 12 are required. With an optical actuator, a modulation signal is generally inputted to the p-electrode 11 in the case of an anodic drive, the modulation signal being inputted to the n-electrode 12 in the case of a cathodic drive, while other electrodes are coupled to GND. Accordingly, the electrode coupled to GND is put to common use (integrated) with the respective electrodes of adjacent channels, thereby reducing the number of the electrodes in use. By so doing, the number of interconnections up to the photonic device can be reduced, thereby enabling high-density packaging to be realized. As is the case with the first embodiment of the invention, the present array optical device is mounted on a substrate 15, and a driver integrated circuit (IC) is also mounted thereon, thereby making up an arrayed optical module.

### Third Embodiment

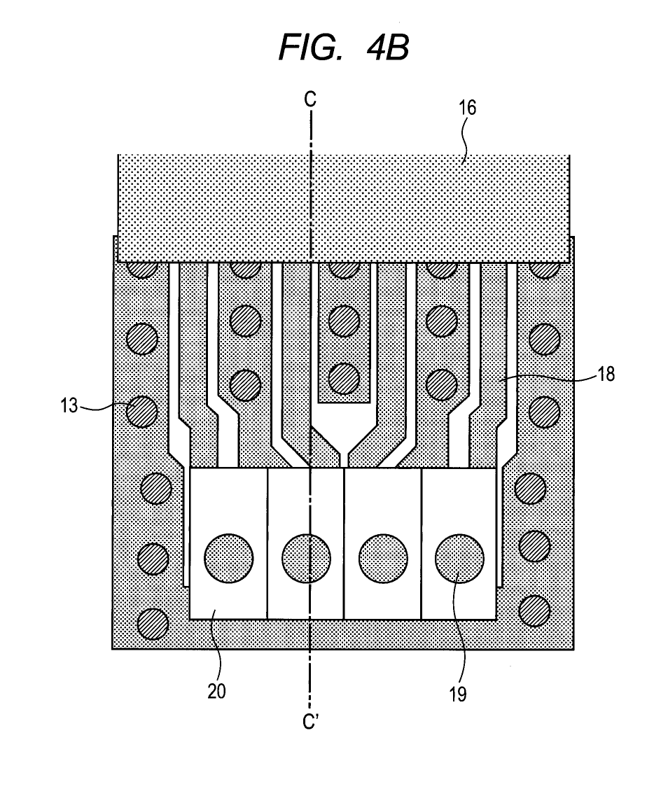

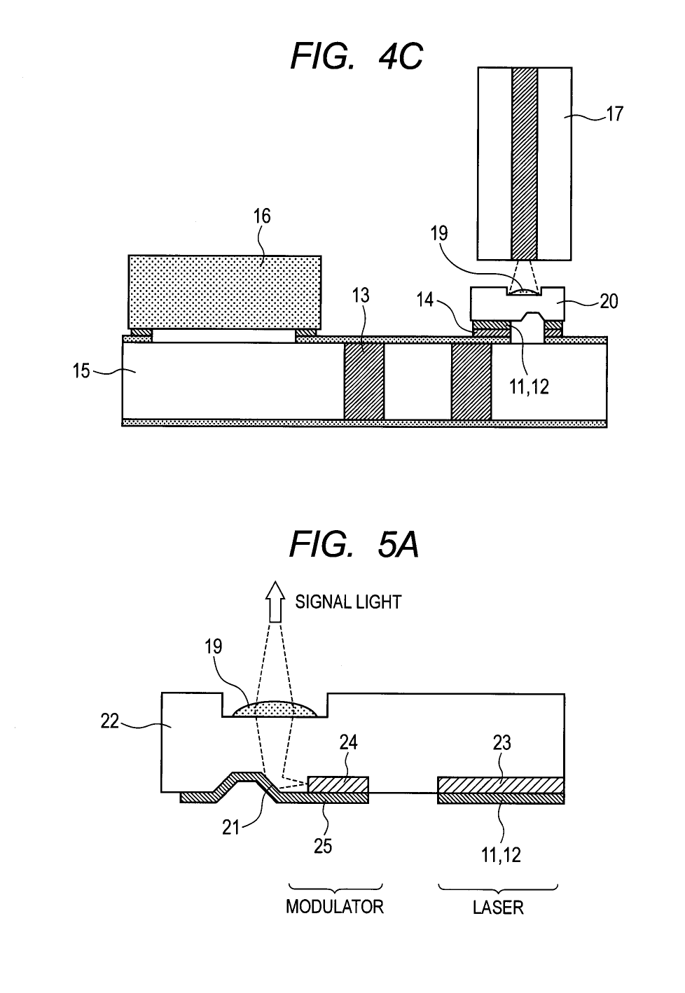

There is described hereinafter a third embodiment of the invention. FIG. 4A(a) is a sectional view showing a surface-emitting type arrayed optical module, and FIG. 4A(b) is a top view of the surface-emitting type arrayed optical module (an electrode pattern of the rear surface is shown as seen in a perspective view).

A photonic device is an edge-emitting type array optical device 10. A mirror 21 and an integrated lens 19 are formed on the same substrate as this light-emitting device is formed. The mirror is formed on the same plane as electrodes 11, 12 are formed while the integrated lens is formed on the rear face of the substrate. An electric field is applied to the electrodes 11, 12, whereupon a light beam outgoing from an active layer 23 is propagated in a semiconductor 22. The light beam has its optical path bent by 90° by the action of the mirror 21 to fall on the integrated lens 19 on the rear face, whereupon the light beam outgoes from the semiconductor 22 while an aperture for light is lessened. These surface-outgoing type light-emitting devices are placed in a line at intervals for every 250 μm, thereby forming a surface emitting array optical device 20. Further, when the photonic devices are arranged in an array, the photonic devices are disposed such that a layout of the p-electrode 11 and the n-electrode 12 is reversed from that for the light-emitting device in an adjacent channel. As a result, the respective p-electrodes 11 of adjacent channels will be disposed in close proximity to each other while the respective n-electrodes 12 of adjacent channels will be disposed in close proximity to each other. At this point in time, since a modulation signal is inputted to the p-electrode 11 in the case of the anodic drive, the modulation signal being inputted to the n-electrode 12 in the case of the cathodic drive while the other electrodes are at a ground potential GND, there will arise no problem even if the electrode coupled to GND and the electrode of an adjacent channel are in common use to thereby reduce the number of the electrodes.

FIG. 4B is a top view of an optical module with the surface-emitting type array optical device 20 mounted thereon. A driver integrated circuit (IC) 16 is disposed on a side of the surface-emitting type array optical devices 20, adjacent to the electrodes, and the driver IC 16 is electrically coupled to the surface-emitting type array optical devices 20 via respective high-frequency lines 18. By taking crosstalk with an adjacent channel, in particular, into consideration, use is made of coplanar lines; however, use may be made of a high frequency line such as a micro-strip, and so forth. The surface-emitting type array optical device 20 is mounted on the substrate 15 by flip chip bonding using the AuSn solder 14. Further, the electrode coupled to GND of the surface-emitting type array optical device 20 (the electrode side of the device, where no modulation signal is inputted) and the electrode of an adjacent channel are common use on a substrate 15, thereby enlarging a width of a GND electrode directly under the device. A via is disposed at a position corresponding to the GND electrode as enlarged, thereby causing an electrical distance up to GND to be shortened. As a result, radiation characteristics at the position of the device are improved, and excellent high-frequency characteristics can be obtained.

FIG. 4C is a sectional view of the arrayed optical module, taken on line C-C′ in FIG. 4B. Because mounting by the flip chip bonding is adopted, the integrated lens 19 is positioned on a side of the surface-emitting type array optical device 20, opposite from the substrate, and a light beam outgoes therefrom. In the case of using the edge-emitting type array optical device, the active layer 23 was low (20 μm or less) in height from the substrate 15, so that the active layer 23 did not match in height a core part of the optical transmission medium 17, rendering it impossible to dispose the active layer 23 except for at the end face of the substrate. For this reason, it was necessary to route an electrical interconnection in the substrate as far as the end face of the substrate, having thereby raised problems such as signal deterioration, crosstalk with other channels, and so forth. However, with the use of the surface-emitting type array optical device 20, it has become possible to dispose the photonic device at a site on a flat plane other than at the end of the substrate, so that highly efficient coupling to the optical waveguide 17 can be realized, the electrical interconnection in the substrate can be shortened in length, and bulk data can be transmitted at a low loss.

### Fourth Embodiment

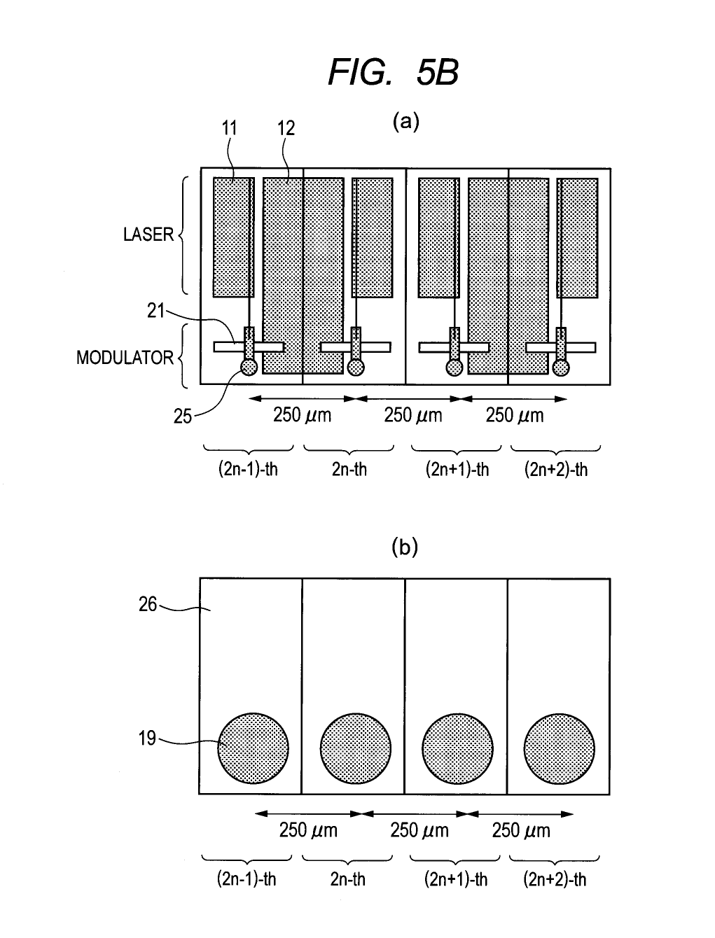

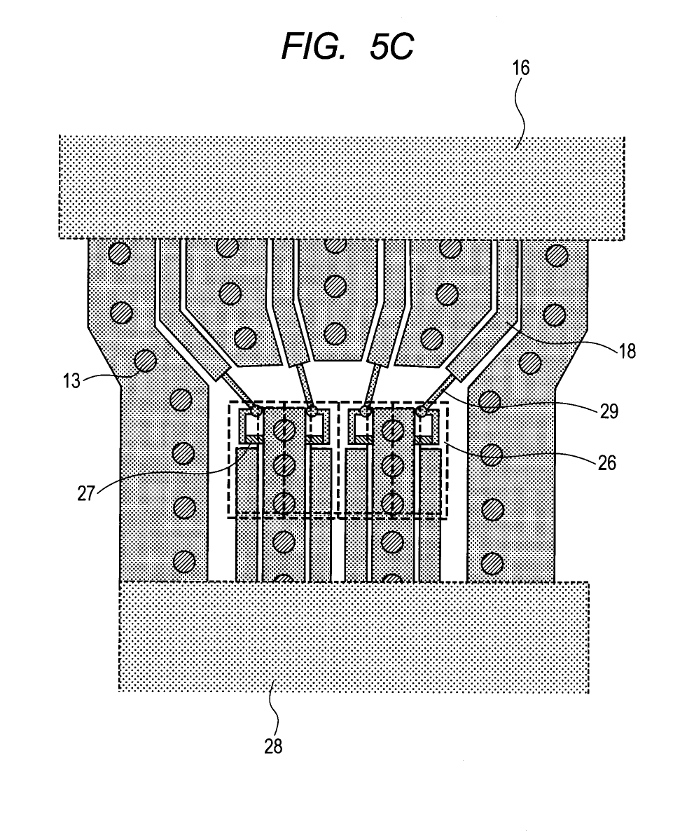

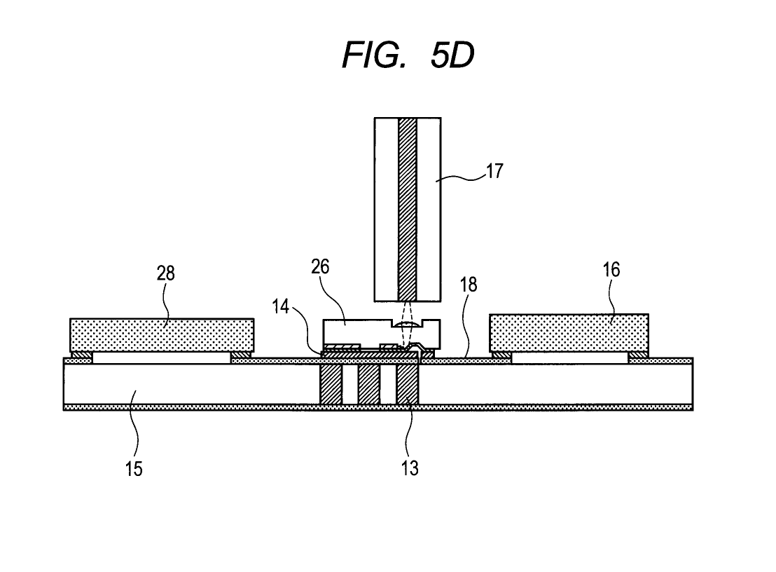

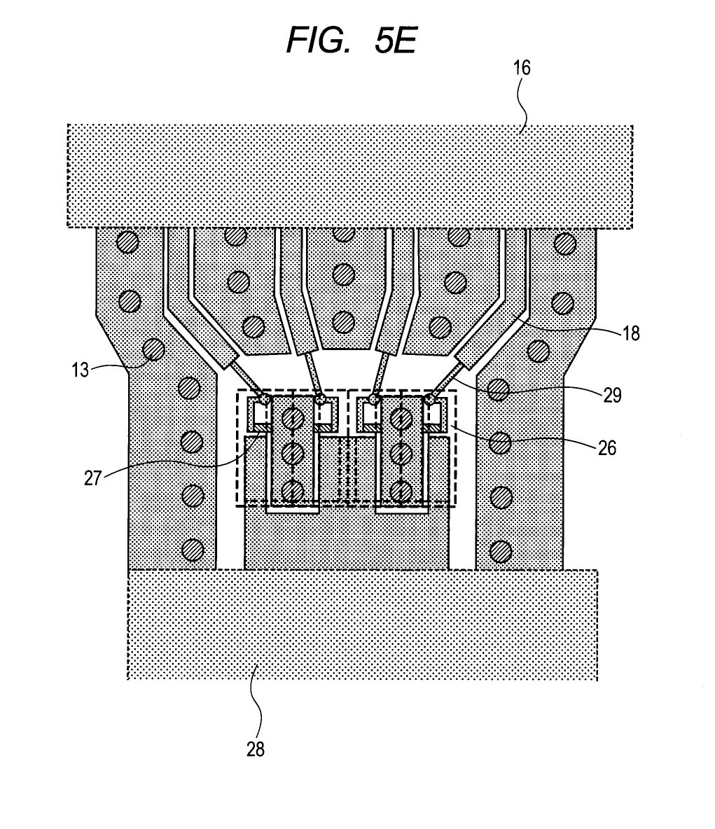

There is described hereinafter a fourth embodiment of the invention. FIG. 5A is a sectional view showing the construction of an electronic absorption (EA) modulator-integration surface-emitting type photonic device. The photonic device is made up of two blocks, namely, a laser for emitting light, and a modulator for causing a change in light transmission amount. For this reason, the construction of the photonic device becomes more complex as compared with one for use in the direct modulation system, however, the photonic device is excellent in the high-frequency characteristics, and is therefore used in the field of transmission overlong distances. An outgoing light beam from an active layer 23 of the laser falls on a modulator 24. The light beam incident on the modulator has a light transmission amount changed by the agency of a voltage applied to a modulator electrode 25, thereby generating a modulated optical signal that has undergone amplitude modulation. The modulated optical signal path is converted to 90° angle direction by a mirror, whereupon light emitting from a integrated lens 19.

FIG. 5B(a) shows an electrode composition of the EA modulator-integration surface emitting array optical device 26, and FIG. 5B(b) shows the rear face composition of the EA modulator-integration surface emitting array optical device 26. Electrodes are made up of a p-electrode 11 of the laser, and both a p-electrode 25 and an n-electrode 12 of the modulator, and respective n-sides of the laser, and the modulator are put to common use through the electrodes of the device. Further, as to respective electrode composition of adjacent channels, the respective electrodes are disposed so as to be ax symmetrical with respect to an optical axis, and the respective n-electrodes of the adjacent channels are in common use. Further, an interval between respective light-outgoing directions is set to 250 μm. Further, a integrated lens 19 is disposed at a light-outgoing position as shown in FIG. 5B(b), thereby widening tolerance of a structure for adjusting outgoing light by stopping down the lens, and optical coupling.

FIG. 5C shows an electrode pattern of a substrate 15, and a peripheral construction thereof, and FIG. 5D is a sectional view of the substrate 15. A laser driver integrated circuit (IC) 28, a laser driver integrated circuit (IC) 16 for a modulation signal, and a terminating resistor 27 are disposed around the EA modulator-integration surface emitting array optical device 26. ADC current is applied from the laser driver IC 28 to drive a laser, thereby causing light emission. A high-speed signal at 25 Gbps or higher is delivered from the driver IC 16 for the modulation signal. Accordingly, the driver IC 16 is coupled to the electrode 25 of the modulator of the EA modulator-integration surface emitting array optical device 26 via a high-frequency line 18. Further, unless the impedance of the high-frequency line matches the impedance of the terminal resistance, a signal is not imputed to the modulator of the photonic device. However, the modulator is a capacitive component having a high impedance. Accordingly, in order that a signal is inputted with high efficiency, the terminating resistor 27 is disposed in the vicinity of the array optical device 26 so as to be in parallel with the modulator. Further, an impedance component is added by installing a high-impedance line 29 to cause resonance, thereby holding peaking in an attempt for a wider bandwidth. A via 13 is provided in respective electrode parts on the substrate 15 side of parts to be coupled to respective parts in common use with the respective n-electrodes of the channels adjacent to each other, thereby providing a modulator-integration type arrayed optical module excellent in high-frequency characteristics, and capable of carrying out a high-temperature operation. Further, with an array optical device, it is difficult to draw all the terminating resistors 27 to outside the photonic device, so that the high-impedance line is caused to pass through a portion of the device between the modulator and the laser, where the electrodes are separated from each other, thereby coupling a terminating resistor fabricated by a thin-film process to a substrate pattern to which the n-electrodes of the array optical device are to be coupled. Further, as shown in FIG. 5E, since respective laser drive parts of the device represents a DC component, there will arise no problem even if the respective laser drive parts are in common use before executing light emission.

### Fifth Embodiment

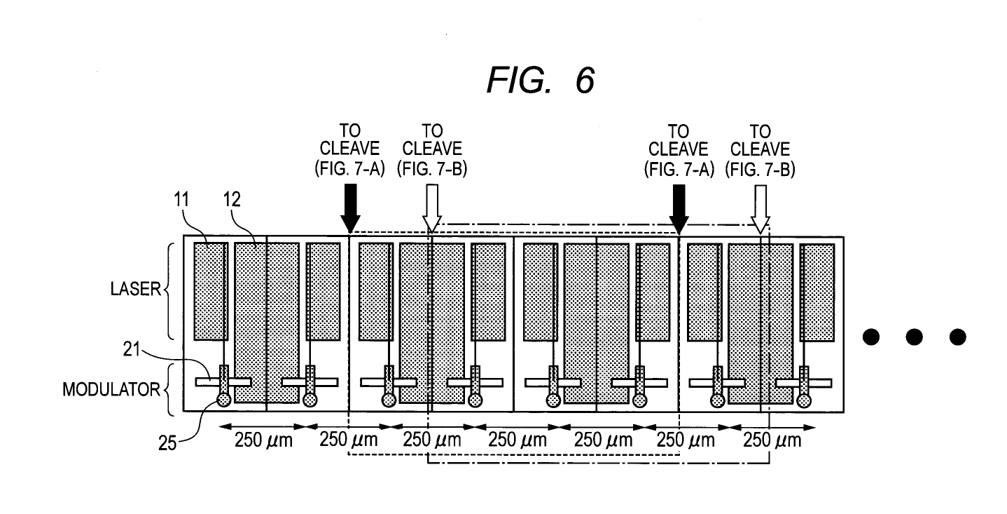

Now, there is described hereinafter the case of manufacturing a 4-chip arrayed optical module according to the present embodiment. FIG. 6 is a block diagram of a chip bar of an array optical device, in such a state as cut out of a wafer.

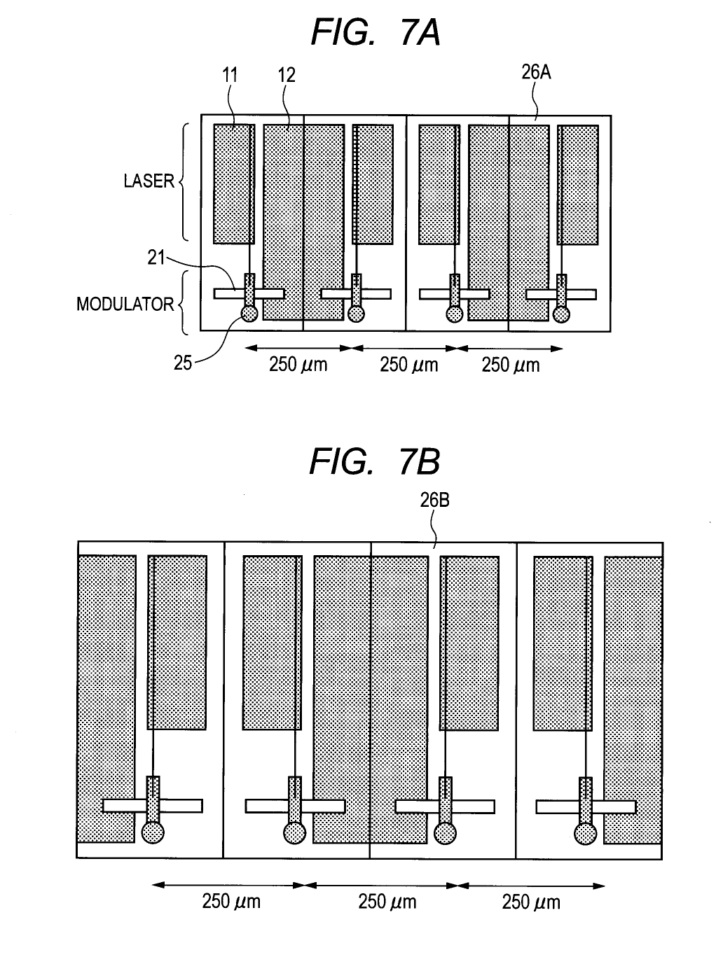

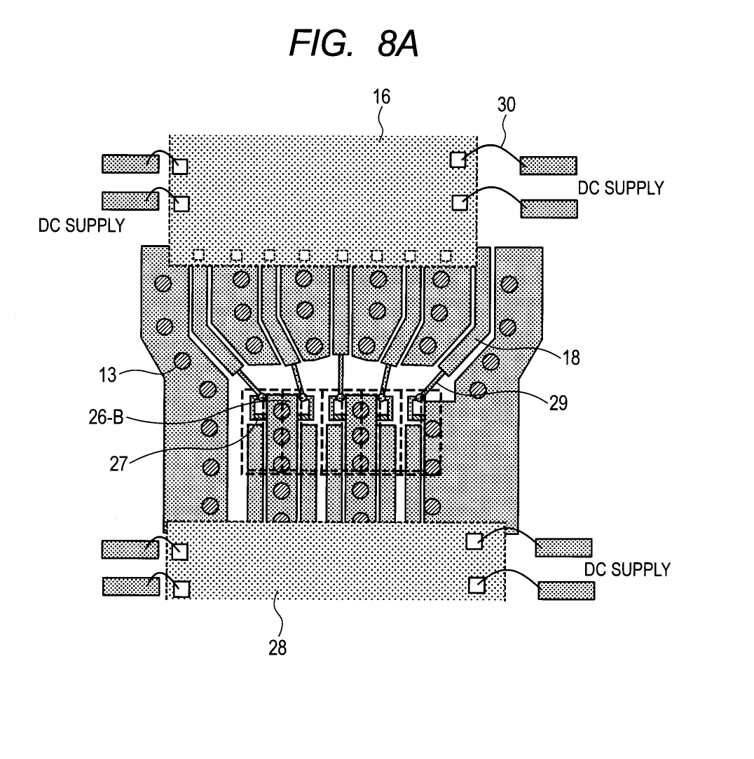

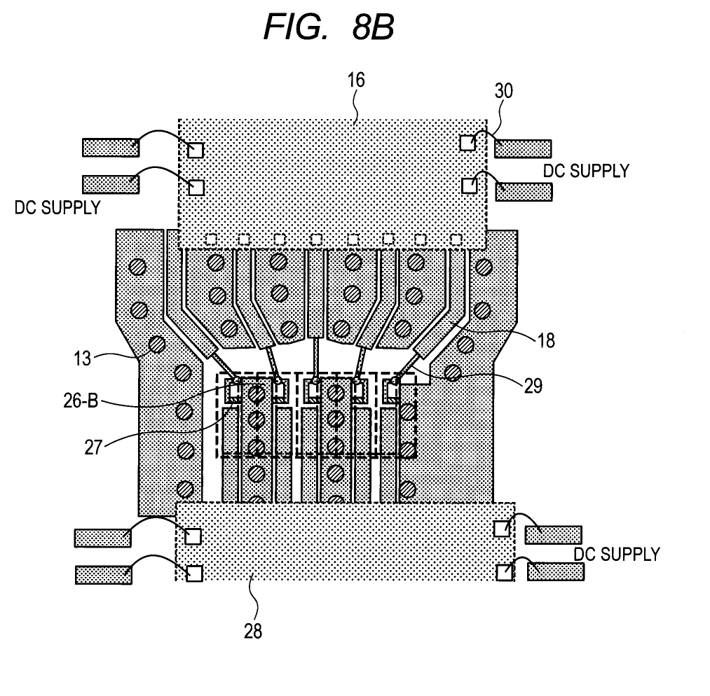

A plurality of photonic devices is placed in a line at pitches for every 250 μm. With this state as it is, electrodes are probed to check operation thereof, thereby executing chip selection. In this process, the array optical device is cleaved at every spots thereof, where 4-channels each will come into operation, and the array optical device is divided into chips. In this case, if the electrode layouts of the respective photonic devices are equal to each other, the electrode layout of a 4-chip array optical device remains the same at all times at whichever spot the array optical device is cleaved. However, in the case where two chips in pairs are disposed, as is the case with the present invention, there are formed 4-chip array optical devices differing in electrode layout from each other, as shown in FIGS. 7A, and 7B, respectively. For this reason, if the array optical device is cleaved in the same pattern at all times, there will arise a possibility that a photonic device for a normal operation need be discarded. Accordingly, a substrate 15 is provided with an electrode construction having a number of electrodes, more than the number of the photonic devices of the array optical device so as to be able to cope with the chip having the electrode layout shown in whichever of FIGS. 7A, and 7B. By so doing, even if an array optical device has whichever electrode pattern, shown in FIGS. 8A, and 8B, respectively, the array optical device can be mounted. More specifically, the array optical device is provided with electrodes for mounting, corresponding to the number of the photonic devices, more than the number of communications channels.

After the photonic devices 26A, 26B are mounted on the substrate, positioning with respective high-frequency lines 18 at the positions of respective devices that can be driven is adjusted, and a laser driver integrated circuit (IC) 28 and a modulator driver IC 16 are mounted on the substrate. Those constituents are fixed by use of the flip chip bonding because a high frequency portion is responsible for deterioration in characteristics such as bandwidth deterioration, and so forth, due to reflection of impedance discontinuity, and so forth. Otherwise, a low-speed signal such as a control signal, and so forth, a DC supply, and so forth are electrically connected via a wire 30. By so doing, enhancement in the yield of an array optical device chip is aimed at without wasting the photonic device that can be normally driven.

### Sixth Embodiment

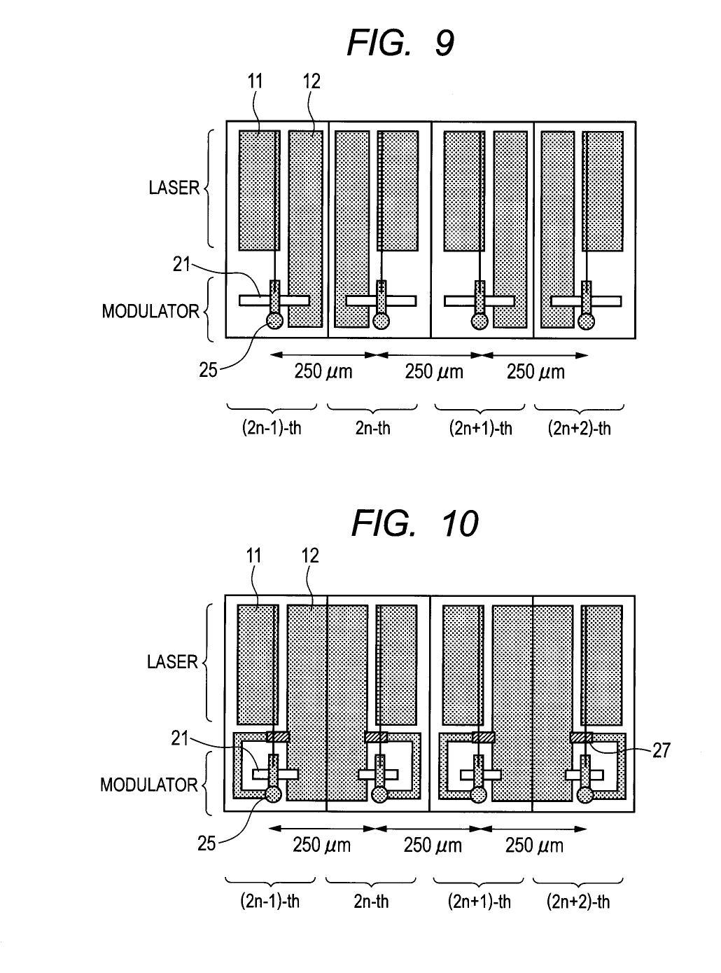

FIG. 9 shows an example of the electrode layout of a modulator integrated surface emitting array optical device 26. In order to enable a chip to be cleaved with ease, adjacent photonic devices are brought to close proximity to an n-electrode layout, however, the n-electrodes are not put to common use over the device. However, in order to obtain excellent high-frequency characteristics, and radiation characteristics, the n-electrodes on a side of the device, adjacent to a substrate 15 with the device mounted thereon, are in common use, and vias are disposed directly under the device.

### Seventh Embodiment

FIG. 10 shows an example of the electrode layout of a modulator integrated surface emitting array optical device 26. Electrodes are disposed such that the respective n-electrodes of photonic devices adjacent to each other, and the respective p-electrodes of photonic devices adjacent to each other are each at a proximity layout. In this case, there will be no change in advantageous effect regardless of whether the electrodes are in common use over the device or on a side of the device, adjacent to a substrate 15. For a modulator to obtain excellent high-frequency characteristics, a terminating resistor 27 is required. Accordingly, while there has so far been described the embodiment in which the terminating resistor is disposed on the side of the device, adjacent to the substrate, a terminating resistor formed of a thin-film resistance, or a mesa resistance is disposed over the semiconductor 22 in this case. Because an interconnection has been routed through a narrow range between the electrodes on the laser side, and the electrodes on the modulator side, respectively, in the past, there has existed the risk of the interconnection short-circuiting to other electrodes due to displacement in mounting position. On the other hand, if the device is provided with the terminating resistor 27, this will enable the terminating resistor 27 to be formed by the same process as the electrodes for the laser, and the electrodes for the modulator are formed, so that accuracy of relative position with a peripheral electrode pattern can be at a high precision. As a result, even in the case where displacement in mount-position occurs upon packaging and an AuSn solder 14 flows to the surroundings, the risk of short-circuiting to surrounding electrodes can be significantly decreased.

### Eighth Embodiment

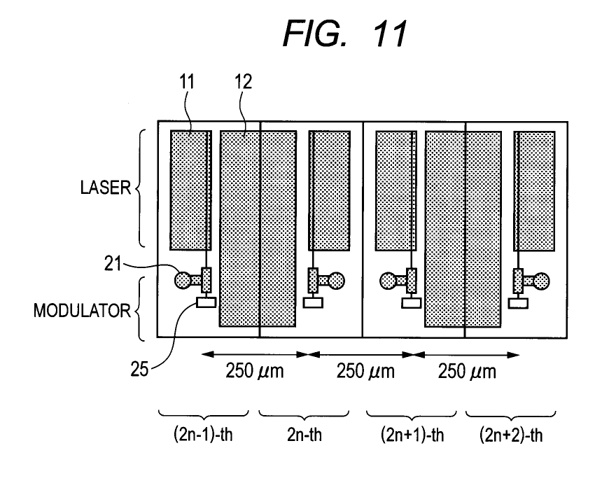

FIG. 11 shows an example of the electrode layout of a modulator integrated surface emitting array optical device 26. Electrodes are disposed such that the respective n-electrodes of photonic devices adjacent to each other, and the respective p-electrodes of photonic devices adjacent to each other are each at a proximity layout. In this case, there will be no change in advantageous effect regardless of whether the electrodes are in common use over the device or on the side of the device, adjacent to the substrate 15. With the array optical device 26 that has so far been described, an interconnection for the modulator electrode 25 has been routed along a groove of the mirror 21, which can become a factor for causing a problem such as a beak of the interconnection, and so forth, occurring at a step, and so forth. For this reason, the modulator electrode is disposed immediately beside the modulator in order to prevent the interconnection from being routed around the mirror. As a result, the interconnection for the modulator electrode, over the device, is rendered shorter in length, so that the interconnection on the device side becomes negligible. More specifically, a waveform at a position of a substrate 15, corresponding to the modulator electrode, will be a waveform directly applied to the modulator, so that an input signal to the modulator can be found by measurements, thereby enabling analysis, and so forth to be carried out with greater ease.

### Ninth Embodiment

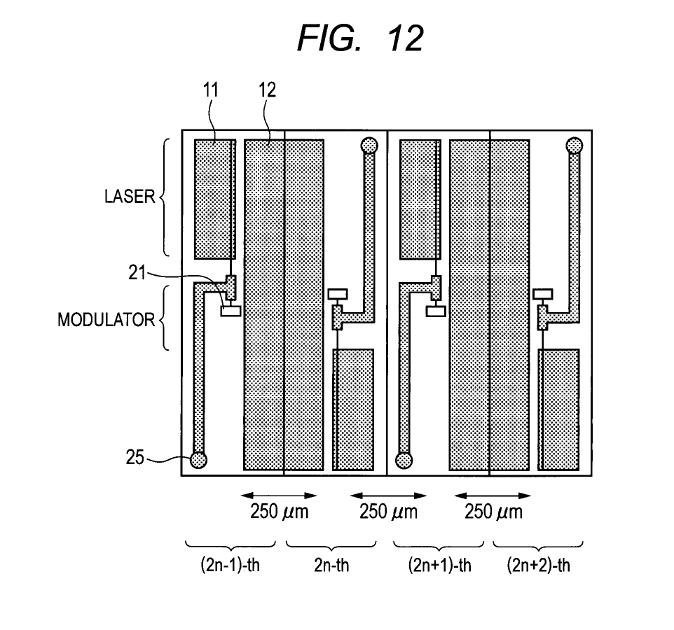

FIG. 12 shows an example of the electrode layout of a modulator integrated surface emitting array optical device 26. Electrodes are disposed such that the respective n-electrodes of photonic devices adjacent to each other, and the respective p-electrodes of photonic devices adjacent to each other are each at a proximity layout. In this case, there occurs a problem in that a channel interval between high-frequency lines becomes narrower. Accordingly, the laser, and the modulator are disposed such that respective constructions thereof are reversed without changing an outgoing position of a surface-outgoing light beam. By so doing, an interval between high-frequency lines can be expanded up to 500 μm although a light-outgoing interval remains at 250 μm, so that crosstalk between channels can be reduced, thereby enabling high-density packaging to be implemented.

### Tenth Embodiment

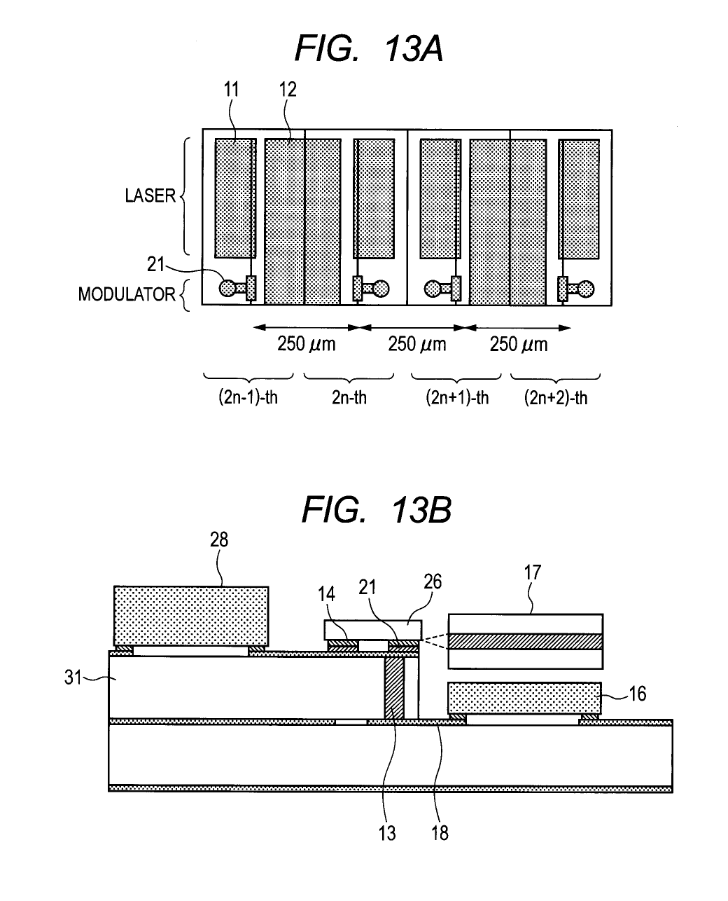

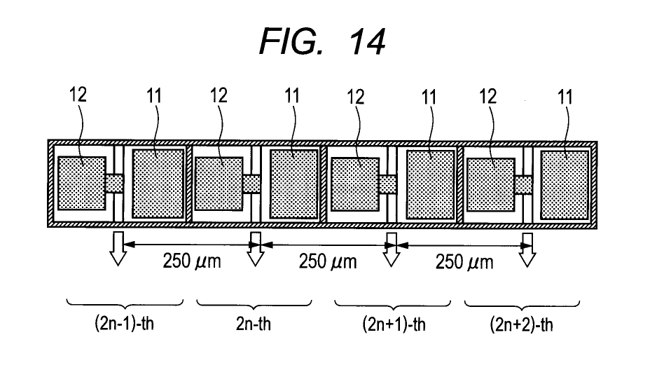

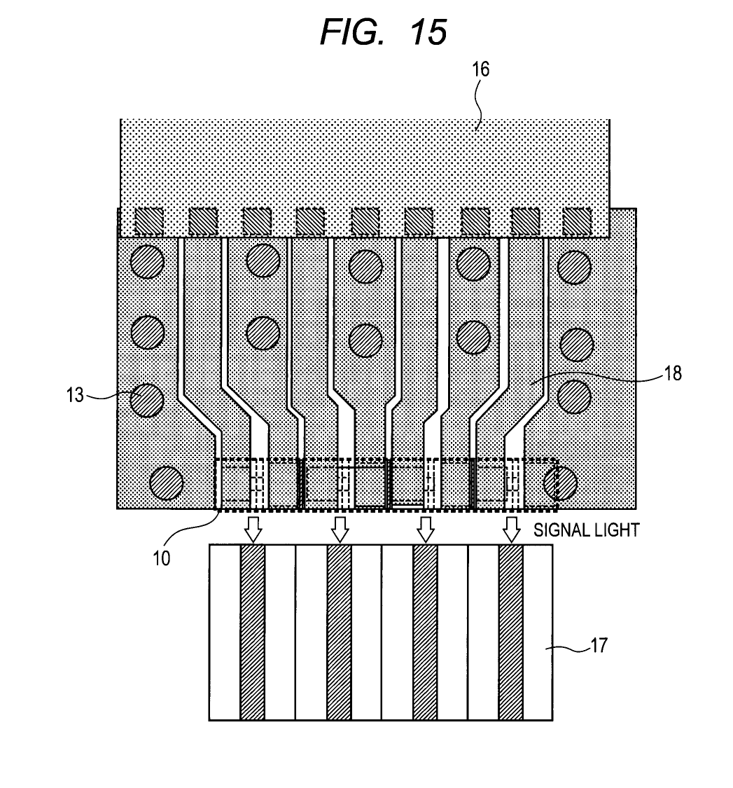

FIG. 13A shows an example of the electrode layout of a modulator integrated surface emitting array optical device 26. Electrodes are disposed such that the respective n-electrodes of photonic devices adjacent to each other, and the respective p-electrodes of photonic devices adjacent to each other are each at a proximity layout. In this case, there will be no change in advantageous effect regardless of whether the electrodes are in common use over the device or on the side of the device, adjacent to the substrate 15. There has thus far been described the surface-outgoing type of the modulator integrated surface emitting array optical device, however, with the edge-emitting type array optical device according to the invention, similar advantageous effects can also be obtained. FIG. 13B is a sectional view showing a packaging state of the edge-emitting type device. In the case of the edge-emitting type device, a driver integrated circuit (IC) 16 for a modulator is disposed in the light-outgoing direction, so that it is difficult to implement coupling to the optical waveguide. For this reason, a multilayer substrate is used in this case to provide the substrate with a step, and the driver IC 16 is disposed at a position lower than the array optical device 26. In this case, a via 13 serving as a high-impedance line can be used in the high-frequency line 18.

What is claimed is:

1. An optical module comprising:
a plurality of photonic devices in array, prepared by integrating a plurality of photonic devices with each other, the plural photonic devices being arranged in such a array as to enable light beams to output in the common direction,
wherein the plural photonic devices each comprise a first electrode, and a second electrode, arranged in the same direction as the plural photonic devices are arranged, and a first photonic device, and a second photonic device, adjacent to each other, and making up the plural photonic devices, are disposed in such a way as to dispose a mirror image of each other.

2. The optical module according to claim 1, wherein, in the plural photonic devices, the first electrode, and the second electrode are disposed in such a way as to be asymmetrical with respect to an optical axis for light emission.

3. The optical module according to claim 2, wherein, in the plural photonic devices, the respective first electrodes of the photonic devices adjacent to each other, or the respective second electrodes of the photonic devices adjacent to each other are integrated together to serve as a third electrode.

4. The optical module according to claim 1, further comprising:
a substrate with the photonic devices in array, mounted thereon,
wherein the substrate comprises a fourth electrode, and the first electrode of the first photonic device, and the second electrode of the second photonic device are mounted on the fourth electrode.

5. The optical module according to claim 4, wherein the substrate has a via disposed directly under the fourth electrode.

6. The optical module according to claim 1, wherein mounting is executed by use of flip chip bonding.

7. The optical module according to claim 1,
wherein the photonic device is an optical modulator, and
wherein the first electrode is the electrode of the optical modulator.

8. The optical module according to claim 7, wherein the optical modulator is a direct modulation laser or a modulator-integration laser.

9. The optical module according to claim 3, wherein a number of resistors, identical to the number of the photonic devices coupled to the third electrode, are disposed.

10. The optical module according to claim 1, further comprising:
a substrate with the photonic devices mounted thereon,
wherein the substrate comprises a number of electrodes, corresponding to the number of the photonic devices, more than the number of communications channels.

11. The optical module according to claim 3, further comprising:
a substrate with the photonic devices in array mounted thereon,
wherein the substrate comprises a fourth electrode, and
wherein the first electrode of the first photonic device and the second electrode of the second photonic device are mounted on the fourth electrode.
